(19) United States
(12) Patent Application Publication
(10) Pub. No.: US 2004/0170856 A1
(43) Pub. Date: Sep. 2, 2004

(54) Laminated wood products and process for making the same

(76) Inventors: Bill Arndell, Wilmington, DE (US); Herbert R. Gillis, Laughlin, NV (US)

Correspondence Address: Patent Counsel, Huntsman International LLC, 286 Mantua Grove Road, West Deptford, NJ, 08066-1732, US

(21) Appl. No.: 10/724,976

(22) Filed: Dec. 1, 2003

Related U.S. Application Data
(60) Provisional application No. 60/430,913, filed on Dec. 4, 2002.

(51) Int. Cl. B32B 31/00

(52) U.S. Cl. 428/535; 156/331.4; 156/307.3

(57) ABSTRACT

Process for the manufacture of adhesive laminated wood products and laminated wood products produced thereby. The process is especially well suited to the production of laminated veneer lumber using fast curing one component polyisocyanate adhesives. The process provides for greater economy of resin usage by employing a ribbon coating apparatus.

### CROSS-REFERENCE TO RELATED APPLICATIONS

This application claims priority to U.S. Provisional Application Serial No. 60/430,913, filed Dec. 4, 2002.

### FIELD OF THE INVENTION

The invention is directed towards methods for the production of laminated wood products and laminated wood products produced thereby.

### BACKGROUND OF THE INVENTION

Techniques for the manufacture of composite lumber products from veneers are quite well known. These techniques typically involve the application of an adhesive resin to the surfaces of one or more wood veneers, followed by stacking and pressing of the veneers to produce an adhesive bonded laminate. The pressing is generally accompanied by heating of the treated veneers in order to accelerate curing of the adhesive, although cold pressing has also been used. Well-known examples of adhesive bonded laminated wood products include, without limitation, plywood, laminated veneer lumber (LVL), and parallel strand lumber.

Adhesives known in the art for manufacturing laminated wood products are predominantly thermosetting adhesives. These include phenol formaldehyde (resole) resins, commonly referred to as PF resins; urea formaldehyde resins (UF resins); melamine formaldehyde resins (MF); resorcinol formaldehyde resins (RF); polyisocyanate adhesives; and various combinations of the foregoing. Phenol formaldehyde (PF) based adhesives are the most widely used, especially for the manufacture of commodity laminated wood products, such as plywood. PF, and related resins types such as UF, RF, and MF, liberate water during the curing process, which limits the moisture content of the veneers that may be used with these kinds of adhesives. The moisture content of the veneers must typically be below 10% by weight of the veneer (defined as wood plus water), and usually less than 7% by weight. Unfortunately, raw veneers often have a much higher moisture content and must be dried in order to reduce the moisture content to acceptable levels, which is energy intensive and costly. Additionally, PF, as well as UF, MF, and RF type resins require heat in order to cure, which places severe limitations on the thickness (i.e. the number of veneers that may be stacked) of the laminates that can be economically produced. The introduction of heat is typically from an external source, such as a heated press. Thicker laminates require more time for heat transfer, and, therefore, as laminate thickness increases, residence time in the press increases.

Plywood products are relatively thin laminates, typically about an inch or less in final thickness. The use of hot pressing with PF type resins is therefore well suited to the production of plywood products. However, engineering products, such as LVL, are comparatively thick laminates, generally greater than one inch, and typically greater than two inches or more in final (cured) thickness. LVL laminates may often be three to six inches or more in final thickness. In addition, LVL products are used in demanding structural applications, such as roof beams, where bond quality is critical. The production of such high quality thick laminates is much more difficult with PF resins than in the case of plywood because press times of many hours are required to produce the thickest LVL products, and such long press times are generally uneconomical.

One versed in the art of the manufacture of LVL, especially standard 1.5″ and 1.75″ thick North American LVL, is aware that the standard adhesive for this application is PF resins and that the standard method of applying adhesive to veneers includes spraying, curtain coating, roll coating, and brushing (curtain coating being the most prevalent). It is also known that the LVL billet (stacked veneer with adhesive applied) requires 18-22 minutes of press time in a 300° F.-360° F. platen heated press under 175-250 psi pressures before they can be removed from the press. Even newer extraordinary measures to reduce this press time requirement, such as microwave preheating or RF dielectric heating while in the press, can reduce this press time only to 12-22 minutes. These measures are necessary to obtain glueline temperatures in the center of a LVL billet of 212° F. for 90 seconds, the generally recommended cure conditions for PF adhesives for LVL manufacture. Removing LVL billets from a standard press prior to the full 18-22 minute cure times results in under-cured adhesive gluelines and LVL billets of unacceptable quality as determined by wood failure testing or bending strength determinations, including wood failures from a chisel test of less than 80% or bending strengths of less than is required from building code regulations for a given LVL construction.

There has been a growing level of interest in the use of polyisocyanates and modified variants thereof as adhesives for laminated wood products because the chemistry of the cure of polyisocyanates is quite different from PF type adhesives. Polyisocyanates react with the moisture in the substrate (i.e. the veneers) to produce polymeric ureas, so veneers with higher moisture content can be used with certain polyisocyanate type adhesives. Although the curing of polyisocyanate adhesives generally benefits from heating, the requirement is not as strong as for PF resins. Certain modified (fast curing) polyisocyanate type adhesives can be cold cured (i.e. without application of external heat), a major advantage for the preparation of thick laminates, such as LVL.

The most commonly used polyisocyanate wood adhesives are based on polyisocyanates of the MDI (methylene diphenyl isocyanate) series. Polyisocyanate based wood adhesives for lamination have been formulated for both one component and two component application. In the one component mode, a polyisocyanate is applied to the veneers and cures by reaction with moisture in the wood. This is the simplest and most widely used cure method. The curing of the polyisocyanate adhesive in one component mode is sometimes accelerated by spraying a fine mist of water onto the veneers. In the two component mode, a polyisocyanate is mixed with an organic polyfunctional isocyanate reactive material, such as a polyol, and the mixture is then immediately applied onto the veneers. The mixing of the polyisocyanate and the polyol initiates a curing reaction (polyurethane formation), which may be used in combination with moisture curing. The two component mode is less preferred due to its greater complexity.

A major factor in determining the economics of laminate manufacture is how rapidly the laminates can be cured in the press. For this reason, there has been a significant effort devoted to the development of “fast cure” one-component polyisocyanate adhesives. These “fast cure” polyisocyanate resins generally comprise a polyfunctional isocyanate terminated prepolymer dissolved in an excess of the monomeric polyisocyanate. The prepolymer contains groups that are catalytic for the moisture activated curing reaction and render the bulk polyisocyanate more hydrophilic. Prepolymers derived from alkoxylated aliphatic amines are preferred for this purpose. These alkoxylated aliphatic amines contain tertiary aliphatic amine groups, which catalyze the reaction of the resulting prepolymer modified polyisocyanate with moisture. The more preferred alkoxylated aliphatic amines also contain a plurality of oxyethylene residues, which increase the hydrophilicity of the derived prepolymer modified polyisocyanates. Combinations of prepolymers are sometimes used. The prior art contains various examples of fast curing polyisocyanate wood adhesives that contain prepolymers and are particularly well suited to the production of laminated wood products.

Despite their advantages, polyisocyanate adhesives are not without problems. Polyisocyanates in general, and the “fast cure” prepolymer types in particular, tend to react rapidly with moisture. This reaction is difficult to control and often creates difficulties during resin application to the wood veneers, including premature gelling of the resin. The fast gelling nature of the polyisocyanate resins, particularly the fast cure prepolymer types, requires that the resin be applied to the veneer in a single pass because there will generally not be time for a second pass. Additionally, the coating application process must be very precise because any resin not successfully applied to the veneer or that which runs off the veneer will be wasted because the resin cannot be recycled due to the fast gelling nature of these resins. Prior art means for the application of the polyisocyanate resin to the veneer have not been particularly efficient, and this has hindered the use of such resins in the manufacture of laminated wood products. Known means for the application of these resins to the veneers include spraying, curtain coating, roll coating, and brushing. All of these known means are prone to serious problems with resin wastage and/or fouling of the coating apparatus due to the rapid onset of gel formation.

Therefore, there is a strong need in the laminated wood products industry for a better, more efficient means of exploiting the advantages of polyisocyanate wood laminating adhesives, especially the fast curing one component polyisocyanate adhesives. One means of meeting this goal is to improve the method of adhesive application to provide for lower resin wastage without fouling of the coating apparatus. The method should be capable of applying the resin to the veneer accurately, with adequate coverage, and in a single pass. The coating apparatus should provide for transit of the veneer through the apparatus and the resin dispensing component of the apparatus should preferably not come into physical contact with the surface of the veneer because such physical contact, as in roll coating and brushing, tends to promote fouling and is therefore highly undesirable.

Liquid moisture curable isocyanate adhesives have been known to the wood products industry for some time and have been used in products such as finger-jointed lumber and wooden I-beams. However, these adhesives have not been used in LVL applications because a suitable application system has not been available for the application of these types of adhesives. Standard application methods that are in use for LVL manufacture, if used with liquid moisture curable isocyanate adhesives would result in fouled equipment within a few hours of use due to the adhesives reaction with moisture in the air and the recycle loop aspects of the standard application methods. In addition, ribbon coating techniques have been known to several other industries but have been considered unusable and unnecessary for the LVL industry due to its expense and impracticality for use with highly caustic and heavily filled PF adhesives. The use of liquid moisture curable isocyanate adhesives in conjunction with ribbon coating application techniques for the manufacture of LVL and other laminated wood products results in a system that brings advantages to could not otherwise have been practically realized.

### SUMMARY OF THE INVENTION

It has been unexpectedly and surprisingly found that the use of a ribbon coating apparatus results in a significant improvement in the efficiency of resin usage when fast curing one component liquid polyisocyanate laminating adhesives are used. The coating of the veneers with the fast curing polyisocyanate resin may be accomplished routinely in a single pass through the ribbon coating apparatus with little or no resin wastage or fouling of the apparatus. The ribbon coating apparatus is uniquely suited to ensure that just the right amount of the fast curing resin is dispensed and in a pattern that optimizes resin spreading over the veneer surface during the pressing of the laminate with little or no excess resin running off of the veneers. This optimizes both resin and wood utilization. The process disclosed is highly reliable, repeatable, and gives consistently high quality laminated wood products. The process is particularly well suited to the efficient production of thick LVL products.

In one embodiment, the invention pertains to a process for the manufacture of laminated wood composites comprises the steps of:

a. providing a plurality of wood veneers;

b. providing an organic polyisocyanate laminating adhesive;

c. providing a ribbon coating apparatus;

d. providing a pressing means;

e. conveying at least one of the plurality of wood veneers through the ribbon coating apparatus and applying a layer of the organic polyisocyanate laminating adhesive in liquid form to a face of the at least one wood veneer in a single pass through the ribbon coating apparatus to obtain a liquid polyisocyanate coated veneer;

f. placing at least one of the liquid polyisocyanate coated veneers in contact with at least one other veneer to form a loose stack of veneers;

g. pressing the loose stack of veneers in the pressing means under conditions suitable to cause the polyisocyanate laminating adhesive to at least partially cure to form an adhesive bonded wood laminate; and

h. removing the adhesive bonded wood laminate from the pressing means.

In another embodiment, the invention pertains to laminated wood products produced according to the process described herein.

### BRIEF DESCRIPTION OF THE DRAWINGS

FIG. 1 is a depiction of resin dispensing apertures of a ribbon coating apparatus.

### DETAILED DESCRIPTION

The prior art appears to lack reference to the use of a ribbon coating apparatus in the production of laminated wood products made from fast curing polyisocyanates as the laminating adhesives. It has been unexpectedly and surprisingly found that the use of a ribbon coating apparatus results in a significant improvement in the efficiency of resin usage when fast curing one component liquid polyisocyanate laminating adhesives are used. The coating of the veneers with the fast curing polyisocyanate resin may be accomplished routinely in a single pass through the ribbon coating apparatus with little or no resin wastage or fouling of the apparatus. The process is particularly well suited to the efficient production of thick LVL products made with fast curing polyisocyanate one-component adhesives, such as the adhesives disclosed in the published international applications WO 200044803 and EP 0723561, which are hereby incorporated by reference. The process is also well suited for the production of other types of laminated wood products, including, but not limited to, plywood and parallel strand lumber.

The ribbon coating apparatus contains means for holding or transporting veneers beneath a resin dispensing component. The resin dispensing component dispenses liquid polyisocyanate resin onto the top face of the veneer and does not come into direct physical contact with the veneers. Typically, the veneers are moved along on a conveyor beneath the resin dispensing apparatus, preferably at a constant rate, as the resin is dispensed onto the face of the veneer. It is within the scope of the invention, however, to move the resin dispensing apparatus, while dispensing resin, over the face of a stationary veneer.

The resin dispensing component deposits a series of discrete resin streams along the face of each veneer. It does not deposit a continuous sheet (or curtain) of resin. Each of the discrete resin streams fall, preferably as a continuous stream, from the dispenser to the veneer surface in a evenly spaced pattern. The result is a series of lines of resin across the face of the veneer. These lines gradually spread out, but need not cover the entire face of the veneer. Further spreading occurs during pressing. The lines of liquid polyisocyanate resin dispensed from the resin dispensing component of the ribbon coating apparatus preferably run parallel to the long axis of the face of the veneer. However, it is within the scope of the invention to dispense the resin along the short axis of the face of the veneer. The spacing between the discrete resin streams is optimized such that the resin spreading, which occurs during the pressing operation, provides for coverage of all or most of the space between the separate lines of deposited liquid resin. This avoids wastage of resin, particularly along the edges of the veneers, where excess resin would tend to run off and drip. The resin dispensing component of the ribbon coating apparatus is typically maintained about 1 to 3 inches above the face of the veneer, preferably from about 1 to 2 inches about the face of the veneer. The exact distance may be adjusted so as to optimize coverage, while minimizing overlap or coalescence of the discrete resin streams.

An example of a particularly preferred resin dispensing component suitable for use in a ribbon coating apparatus is a hollow tube containing a plurality of spaced apertures. The apertures are preferably evenly spaced along the length of the tube. At least one end of the hollow tube is attached to a source of liquid resin. If only one end of the tube is so connected, the opposite end is capped. The tube is arranged above the face of the veneers to be resin treated. The resin is preferably dispensed onto only the upward facing broad surface of the veneer (upper face). The tube is preferably arranged perpendicular to the long axis of the veneer. Arrangement of the dispensing tube parallel to the short axis of the veneer would also work, but would be less efficient. The apertures along the dispensing tube face down, toward the upper facing surface of the veneer. The apertures are preferably arranged in a straight line. Resin enters the dispensing tube, optionally under externally applied pressure from a pump, and flows out through each of the apertures. Preferably, the flow rate of resin through each of the apertures is about the same. The resin falls onto the veneer in continuous, discrete, streams forming parallel lines of liquid resin on the face of the veneer. The resin may gravity feed, or it may be pumped. The size of the apertures and the flow rate of resin into the dispensing tube are adjusted until the optimum amount of resin is dispensed on each veneer. Other control variables include the viscosity of the resin, which is in turn related to the temperature of the resin.

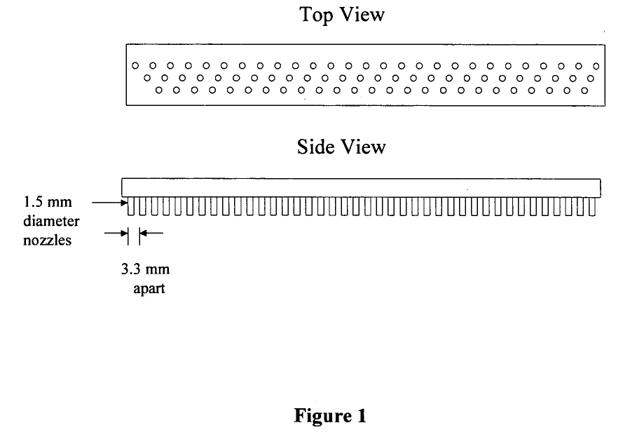

A simple, non-limiting arrangement for the resin dispensing apertures of a ribbon coating apparatus is illustrated in FIG. 1. Variations on the basic idea of ribbon coating, which although different from the embodiment shown here, are within the scope of the invention, as will be apparent to those skilled in the art. Examples of possible variations within the scope of the invention would include, without limitation, the use of a series of individual, independently controlled, resin dispensing heads collectively performing a function similar to the resin dispensing apertures shown in FIG. 1. Another possible variation would be the inclusion of flow control valves on the resin dispensing apertures.

Generally, it is preferred that the ribbon coating apparatus not: atomize the resin (i.e. spray), have features that promote merging of the individual resin streams (i.e. knives or “doctor blades” that would tend to cause the resin to form a continuous sheet), and physically contact the surface of the veneer that is being resin treated. The ribbon coating apparatus should dispense a series of discrete resin streams, preferably evenly spaced, across the width of each treated veneer under conditions such that each stream forms a line of resin liquid on the surface of the veneer. The individual resin streams should not merge prior to reaching the surface of the veneer. All of the resin dispensed from the ribbon coating apparatus should land on the veneer, and specifically on the upward facing broad surface of the veneer.

The resin may be heated as it is applied to the veneer, but is more preferably applied at ambient temperature (i.e. 25° C.). The resin must be in the liquid state as it is dispensed onto the veneer. The resin is preferably a liquid at 25° C. and storage stable for at least 12 hours at 25° C. It is more preferred that the resin be stable in the liquid state and free of solids at 25° C. for at least 3 days, and most preferably for at least 30 days. The viscosity of the resin is preferably constant during the storage period and does not change by more than 10%. The viscosity of the liquid polyisocyanate resin preferably does not change by more than 5% when stored at 25° C. for at least 12 hours.

In preferred embodiments, a single adhesive is used, namely, a liquid moisture curing one-component polyisocyanate adhesive. This single adhesive resin stream is typically loaded into a storage tank connected to the resin dispensing component of the ribbon coating apparatus, optionally through the intermediacy of a pumping means. In the simplest embodiments, the polyisocyanate adhesive resin may be allowed to gravity feed from the storage tank into the dispensing component. The polyisocyanate resin should be stored under an inert (moisture free) atmosphere until it is dispensed onto the wood veneers. Dry air or nitrogen is suitable for this purpose. The storage tank, the connecting lines, the resin dispensing means, the dispensing apertures, and all other components likely to come into contact with the polyisocyanate adhesive should be maintained dry at all times during operation. Otherwise, fouling of the ribbon coating apparatus will occur. The dry state may be maintained by passing a stream of dry air or nitrogen through the system whenever the system is not filled by polyisocyanate adhesive.

In preferred embodiments, the polyisocyanate adhesive is dispensed through a series of evenly spaced apertures on the resin dispensing component of the ribbon coating apparatus onto the upward facing broad surface of the veneer, thereby forming a series of parallel lines of resin along the long axis of the veneer. The lines of liquid resin are preferably non-overlapping at the time they are deposited onto the veneer surface. The rate of resin dispensation (in weight of resin per unit time) is preferably about the same for all the apertures along the dispensing component. The veneers are preferably moved along under the resin dispensing component on a conveyor means. The rate of movement of the veneers along the conveyor means and the rate of resin dispensation are adjusted so as to control the total amount of resin deposited onto each veneer. This amount may vary, but is preferably a constant. The precise means available for adjusting the resin dispensing rate and the conveyor speed will be understood by those skilled in the art.

There is considerable flexibility in the spacing of the resin dispensing apertures along the resin dispensing component of the ribbon coating apparatus, and also in the selection of the diameters of the apertures. In general, the apertures are spaced evenly and in a straight line along the bottom of the resin dispensing component so as to deposit resin directly onto the veneers passing beneath the dispensing component. The spacing of the apertures is preferably between 0.05 inch and 1.00 inch of average separation. Preferably, all the separations are the same. A more preferred spacing is from 0.07 to 0.5 inch, still more preferably from 0.1 to 0.4 inch, even more preferably from 0.1 to 0.3 inch, and most preferably from 0.15 to 0.25 inch. The apertures should most preferably be circular, although it would be within the scope of the invention of employ apertures of other shapes. The diameters of the apertures may be the same or different, but are preferred to be all the same. The ratio of the diameters of the apertures to the distance between the apertures are generally in the range of from 0.01 to 1, but preferably from 0.01 to 0.5, more preferably from 0.05 to 0.3, still more preferably from 0.05 to 0.25, and most preferably from 0.1 to 0.2. The diameter and spacing of the apertures and the distance of the resin dispensing component from the surface of the veneer should be selected so as to achieve the optimum amount of resin per veneer required for the achievement of desired laminate properties, to provide for the most efficient distribution of resin over the face of the face of the veneer, and to minimize resin wastage due to run-off or over application. The lines of resin deposited on the veneers should preferably not overlap until pressing, and the individual resin streams from the resin apertures should preferably not merge or cross. The spacing between the lines of resin should preferably be even and ideally should be such that there is just enough resin spreading during the pressing operation that a glue line is visible between each of the bonded veneers in the pressed laminate but not enough to cause resin run-off during pressing. This ideal situation provides for optimum wood and resin utilization.

The total loading of resin on the veneers will vary with the end use application and depending upon the strength requirements of the final laminated wood product. In the case of LVL, the total resin loading in the final pressed laminate is from about 0.25 to 1% by weight, preferably from greater than 0.5% by weight to less than 1% by weight. The adhesive spread rate on the individual veneers is generally expressed as pounds of resin per 1000 square feet of veneer surface area. A range for this parameter is from about 5 to about 100 pounds, preferably from about 10 to 50 pounds, more preferably from about 10 to 30 pounds, and most preferably from about 15 to 25 pounds of resin per 1000 square feet.

Resin application onto the veneers may optionally be accompanied by a fine water spray or mist in order to accelerate curing of the moisture activated polyisocyanate adhesive. The use of water misting will depend on a number of factors, such as the initial moisture content of the veneers and the press conditions. The amount of water mist when used is generally expressed as pounds of water per 1000 square feet of veneer surface area. A typical range for this parameter is from about 1 pound to about 20 pounds, but more typically from about 3 to 10 pounds per 1000 square feet. The water misting when used is sprayed from a dispensing system separate from the adhesive dispensing system. The water mist may be applied before, during, or after resin application. It is typically applied concurrently with resin application.

In the case of LVL, the veneers are typically large rectangular sheets of wood. They vary in thickness from about 0.05 inch to about 1 inch, but more typically the thickness is from about 0.1 to less than 0.5 inch, and preferably from greater than 0.1 to less than 0.3 inch. The width of the veneers is generally greater than 1 foot and may be several feet in width. The veneers are usually longer in length than in width, and are preferably all of about the same size when flat, so that a laminate with a uniform cross section may be obtained. The veneers are rarely, if ever, perfectly flat prior to pressing. The effective width of the veneers will vary to some degree with the amount of deviation thereof from perfect flatness (curling or cupping). The resin dispensing component of the ribbon coating apparatus is very preferably of a width that does not exceed the broadest effective width of the veneers being resin treated. The resin dispensing component is most preferably equal in length to the effective width of the broadest veneers.

In a typical lamination process, only one side of the veneer is resin treated. The treated veneers are loosely stacked such that the resin coated side of each veneer is placed in contact with the untreated side of the next veneer. Typically, the last veneer in the stack is not resin treated. The loose stack therefore contains no adhesive on the outside surfaces, and preferably no run-off at the edges. Finally, the loose stack is placed in the pressing means and pressure is evenly applied over the stack. This pressing process causes the individual veneers to flatten out and come into full contact with each other, thereby forcing the adhesive to spread out over adjacent uncoated wood surfaces. In the process disclosed herein, there is not so much spreading as to cause run off of the resin from the stack of veneers during pressing.

Because each veneer tends to “cup” in one direction, the veneers in the laminate are oriented alternatively with their concave surfaces facing in opposite directions (up or down) with each successive layer. This alternating morphology is preferred because it causes the forces responsible for “cupping” in the individual veneers to cancel out in the final laminated wood product. The laminate is therefore flat and dimensionally stable after it is removed from the press. This strategy is especially important in laminated veneer lumber (LVL), because the veneers are generally laminated in parallel (with the grain axes of all or most of the veneers facing in the same direction). In LVL, it is highly preferred that a majority of the veneers, preferably all of them, should be oriented with their grain axes parallel to the long axis of the final laminated wood product. This is very important for maximizing the shear strength of long load bearing laminated products, such as beams.

Pressing conditions may vary considerably depending upon the type of laminate, the end use application, the thickness of the laminate, and the adhesive composition. Pressure will typically be between about 100 and 500 psi, but more preferably between about 200 and 300 psi. Temperature will range from ambient (cold cure, at about 25° C.) to 300° C., but more typically from ambient to about 200° C. Press time is determined by cure rate. Cure rate is influenced by factors such as moisture content of the veneers, added water misting (if used) during resin application, the type of adhesive, the thickness of the laminate, and heat transfer (if a heated press is used). Higher press temperature generally means lower press time. Greater laminate thickness generally means longer press time. The press times typically range from about 5 minutes to 6 hours. A preferred range is from about 5 minutes to less than 1 hour, and most preferably from about 5 minutes to less than 30 minutes. The shorter the press time, the better the economics (all other things being equal).

Whereas plywood laminates are generally thin, and contain typically only about 5 veneers or fewer, LVL laminates are usually much thicker and contain typically greater than 10 veneers per laminate. However, the number of veneers in an LVL laminate may be much higher than this. LVL beams have been produced that contain more than 50 veneers, which have a final laminate thickness of 6 inches or sometimes more. The ability of the preferred fast curing one component liquid polyisocyanate laminating adhesives, as described herein, to cure with little or no external heating is a major advantage in making such thick laminates. This fast cure moisture activated property of the preferred adhesives helps to compensate for the enormous heat transfer problems in making thick laminates.

A fast curing polyisocyanate resin of the type represented by LINESTAR™ 4800 engineered lumber adhesive system is typically very sensitive to moisture and due to its crosslinking nature will gel rapidly in the presence of moisture through the formation of urea linkages from the reaction of the free isocyanate groups with water. Once gelled, the resin cannot be dispensed. Accurate application of the resin in a single pass of the veneer is therefore crucial to effective utilization. Recycle of any resin that does not land on the veneer is impossible due to the high reactivity of the resin. Likewise, any resin that runs off the veneers subsequent to resin treatment or during pressing cannot be recycled. Therefore, the resin application means must be both highly accurate and highly efficient. It has been observed that the ribbon coating apparatus as described herein offers a better combination of accuracy and efficiency than all known coating means when used with these fast curing moisture activated polyisocyanate resins. Resin application means, such as rolling, doctor blading, and brushing, that require physical contact between the veneers and the resin dispensing component, although potentially accurate and efficient, are unacceptable in this context due to fouling. The fast reacting moisture sensitive nature of the preferred polyisocyanate adhesive resins would cause rapid gelling of the adhesive on the surface of any roller, blade, or brush that is used. This is made considerably worse by the inevitable presence of loose wood dust and particles on the surfaces of the veneers. Such a combination would result in rapid fouling of the coating means and interruption of the coating process. This is clearly not acceptable in an industrial process. Therefore, resin dispensing components of this kind, which require physical contact with the substrate, cannot be used.

An additional benefit of the highly accurate and efficient ribbon coating apparatus is an unexpected increase in the ability to process veneers with extremely high moisture content (so called “green wood” veneers). The drying of veneers to reduce their moisture content is undesirable due to cost and energy consumption. Even passive aging of green wood or veneers made therefrom is undesirable because this creates an inventory of material that cannot be used and occupies space. Therefore, it would be desirable to be able to process veneers made from freshly cut trees (“green” wood) immediately, without any drying or aging thereof.

Whereas the preferred prepolymer containing moisture activated polyisocyanate adhesives, of the type described herein, are already known to be suitable for lamination of wood with moisture content up to about 15% (relative of the total veneer weight, including both wood and moisture), it has hitherto been more difficult to use these adhesives in the lamination of green wood veneers. It is not completely understood why this is so. One of the principle characteristics of green wood is extremely high moisture content, typically well above 15% by weight and usually above 19% by weight. The moisture content of green wood is often higher than 20% by weight. Moisture content may not be the only factor responsible for the past difficulties encountered in the lamination of green wood, and we do not wish to be bound by any theory.

It has been unexpectedly and surprisingly found that the process disclosed herein, along with the most preferred moisture activated prepolymer containing polyisocyanate laminating adhesives, has improved suitability for the lamination of green wood. The green wood may have moisture contents of greater than 19% by weight (of the total veneer weight), even greater than 20% by weight, and even greater than 22% by weight. The ability to form laminates of green wood without any pre-drying or aging thereof is a major advantage in the industry. This advantage could substantially improve the overall economics of wood laminate manufacture and especially LVL manufacture. By using the process disclosed herein, it is now possible to form useful laminated wood products using freshly prepared veneers from freshly cut trees, which was not known to be possible in the past.

In a preferred embodiment, the laminated wood products comprise at least five veneers and a majority of the veneers in the laminated product are arranged such that their grains lay parallel to the long axis of the laminate. In a more preferred embodiment, the laminated wood products comprise at least ten veneers and at least 70% of the veneers are aligned such that their grains lay parallel to the long axis of the laminate. In another preferred embodiment, the laminated wood product has a thickness of greater than about one inch after it is removed from the pressing means. In still another preferred embodiment, the laminating adhesive consists essentially of a one component polyisocyanate resin comprising one or more polyfunctional isocyanate terminated prepolymers. In another embodiment, the pressing of the loose stack of veneers in the pressing means is accompanied by the application of heat to the stack of veneers in order to accelerate the curing of the adhesive. In a particularly preferred embodiment, a one component prepolymer containing polyisocyanate adhesive is used as the sole adhesive resin, the prepolymer containing polyisocyanate is a liquid at 25° C., and the prepolymer containing polyisocyanate comprises at least one prepolymer that contains one or more aliphatic tertiary amine groups and a plurality of oxyethylene groups. Preferably, the resin dispensing component(s) within the ribbon coating apparatus do not come into direct physical contact with the veneers. In still another preferred embodiment, the veneers may comprise “green wood” having a moisture content of greater than 19%, or even greater than 20% by weight, of the total veneer weight. The embodiments may be practiced successfully even when all the veneers are “green wood” having a moisture content of greater than 19%, or even greater than 20% by weight, of the total veneer weight.

The preferred polyisocyanate resin is a liquid one-component thermosetting resin that cures by reaction with moisture. The reaction with moisture causes the formation of a thermoset network of urea linkages. The polyisocyanate resin is preferably a mixture of polyfunctional isocyanate terminated prepolymers and monomeric polyisocyanates. It is preferred to use this resin as the sole adhesive agent in the lamination process contemplated herein (one component adhesive). The use of additional components, such as organic polyols, in the adhesive application process is much less preferred because it adds complexity to the process and creates greater opportunity for fouling of the apparatus and resin wastage.

The most preferred of these liquid one-component polyisocyanate adhesives contain prepolymers of alkoxylated aliphatic tertiary amines. These alkoxylated aliphatic tertiary amines contain at minimum a plurality of oxyethylene linkages derived from ethylene oxide and nominally at least two terminal primary and/or secondary hydroxyl groups. The nominal hydroxyl functionality is two or higher, typically 2 to 4. These alkoxylated amines usually also contain in addition at least one higher oxyalkylene unit, typically a plurality of oxypropylene units. Examples of suitable alkoxylated amines are those prepared from the reaction of ethylene oxide and propylene oxide with a simple aliphatic amine such as ammonia, ethylene diamine, diethylene triamine, ethanolamine, diethanolamine, triethanolamine, isopropanolamine, diisopropanolamine, triisopropanolamine, mixtures of these, and the like. Among these, ethylene diamine is particularly preferred. An example of a particularly preferred alkoxylated amine is SYNPERONIC® T/304 alkoxylated amine, which is available from Imperial Chemical Industries Plc. SYNPERONIC® T/304 alkoxylated amine is prepared by ethoxylation and propoxylation of ethylene diamine, and is characterized by having a nominal hydroxyl functionality of 4 and a number averaged molecular weight of 1650. In the context of alkoxylated amines, the expression “nominal functionality” is the N—H functionality of the initiator. The concentration of aliphatic tertiary nitrogen atoms in the alkoxylated amine is preferred to-be in the range of from 0.002 to 0.05 eq. N per 100 g. The alkoxylated amine preferably contains no primary or secondary amine groups. The alkoxylated amine preferably contains only primary and/or secondary organically bound —OH groups as the sole isocyanate reactive functional groups.

A wide range of monomeric (or “base” ) polyisocyanates may be used to prepare the preferred prepolymers suitable for use in the process disclosed herein. These include aromatic polyisocyanates, aliphatic polyisocyanates, araliphatic polyisocyanates, heterocyclic polyisocyanates, combinations of these, and the like. Aromatic polyisocyanates are the most preferred base polyisocyanates. Examples of particularly preferred classes or aromatic polyisocyanates include all the isocyanates of the MDI series, the isocyanates of the TDI series, the isocyanates of the NDI series, combinations of these, and the like. The isocyanates of the MDI series are the most preferred due to their low vapor pressure and ease of handling. The preferred members of the MDI series include the widely available MDI diisocyanates, including, but not limited to 4,4′-MDI, 2,4′-MDI, and 2,2′-MDI; the higher methylene polyphenyl polyisocyanate species having —NCO group functionalities of 3 and higher; and combinations of these. The most preferred MDI base isocyanates are liquid at 25° C. and contain mixtures of MDI diisocyanates and higher functionality methylene polyphenyl polyisocyanate species. The preferred MDI base isocyanates have number averaged —NCO group functionalities of from about 2.2 to 3.0, and more typically from about 2.4 to 2.7. An example of a suitable base isocyanate of the MDI series is RUBINATE® M isocyanate, which is commercially available from Huntsman International LLC. RUBINATE® M isocyanate is characterized by having a number averaged isocyanate (—NCO) group functionality of 2.7 and a free isocyanate group functionality of 31.5% by weight. Another example of a preferred MDI series base polyisocyanate is a simple 71:29 w/w blend of RUBINATE® M isocyanate with 4,4′-MDI.

In order to form the preferred fast curing prepolymer containing liquid polyisocyanates for use in the process, the base polyisocyanate is reacted with the hydroxy functional alkoxylated amine, optionally in combination with one or more additional polyols. Typically, the hydroxy functional ingredients are added gradually to an excess of the base polyisocyanate under agitation. Heating is provided, if necessary, to drive the reaction of the hydroxy functional ingredients with the base polyisocyanate to form urethane linkages. Heating, when used, may typically be in the range of from about 40 to about 80° C. for from about 30 minutes to about 3 hours. Heating time and temperature should be minimized in order to prevent unwanted side reactions that could lead to unacceptably high resin viscosity. The fine-tuning of the prepolymer reaction conditions will be well understood by those skilled in the art. The ratio of the ingredients is adjusted so that the final product is an isocyanate terminated prepolymer, which preferably also contains some unreacted monomeric polyisocyanate species, which is liquid at ambient temperatures (25° C.) and of reasonable viscosity. The viscosity of the final liquid prepolymer containing polyisocyanate must be low enough so that it can be transferred to the ribbon coating apparatus and applied to the veneers. Viscosity is inversely related to the final free —NCO group content (percent by weight —NCO) of the prepolymer containing polyisocyanate. The lower the free —NCO concentration, the higher the viscosity. For the preferred prepolymer containing polyisocyanates, based on MDI series base polyisocyanates, the final free —NCO content (weight percent —NCO) of the final prepolymer (as it is used in the process of the invention) is in the range of from about 8% to 30%, preferably from 10% to 29%, more preferably from 12% to 28%, still more preferably from 14% to 27%, and most preferably in the range of 16% to 25%.

In a preferred embodiment, the prepolymer containing polyisocyanate contains a mixture of at least two prepolymers. One of these prepolymers is due to the alkoxylated amine described above. This alkoxylated amine preferably contains a plurality of both oxyethylene groups and a plurality of oxypropylene groups. The prepolymer containing polyisocyanate in this preferred embodiment preferably also contains at least one additional prepolymer derived from a nitrogen free polyol. The nitrogen free polyol is preferably a polyether polyol containing only organically bound primary and/or secondary hydroxyl groups as the sole isocyanate reactive functionality. The nitrogen free polyol preferably has a nominal hydroxyl functionality of from 2 to 6, more preferably 2 to 3, and a number averaged molecular weight in the range of from 200 to 12,000. The number averaged molecular weight range for this nitrogen free additional polyol is more preferably in the range of from 500 to 8000, still more preferably from 1000 to 6000, and most preferably from 2000 to 6000. The expression “nominal functionality”, in the context of the nitrogen free polyether polyol, refers to the active hydrogen functionality of the initiator. The nitrogen free polyether polyol is most preferably a polyoxypropylene-based polyol, which may optionally contain a minor amount of oxyethylene residues. A non-limiting example of a particularly preferred nitrogen free polyol suitable for use as the source of the additional prepolymer is JEFFOL® PPG-2000 polyol. JEFFOL® PPG-2000 polyol is a polyoxypropylene nominal diol of number averaged molecular weight 2000, commercially available from Huntsman International LLC. In the most preferred prepolymer containing polyisocyanate adhesives, the weight ratio of the alkoxylated amine to the nitrogen free additional polyol is from 10:90 to 90:10, more preferably from 25:75 to 75:25, still more preferably from 60:40 to 40:60, and most preferably from 55:45 to 45:55. There are no other prepolymers in this preferred polyisocyanate system.

The viscosity range for the final liquid prepolymer containing polyisocyanate adhesive (at 25° C.) is from about 100 cps to 20,000 cps, preferably from 200 cps to 10,000 cps, more preferably 500 cps to 8000 cps, still more preferably from 1000 cps to 6000 cps, and most preferably from 2000 cps to 5000 cps.

A non-limiting example of a particularly preferred prepolymer containing polyisocyanate adhesive is LINESTAR™ 4800 engineered lumber adhesive system, available from Huntsman International LLC. This isocyanate is made from a base isocyanate consisting of a blend of diphenylmethane diisocyanate isomers and higher functionality methylene polyphenyl polyisocyanates. The base isocyanate is modified by reaction with hydroxy functional organic species to form a mixture of isocyanate terminated prepolymers of a nominally tetrafunctional ethoxylated and propoxylated aliphatic diamine, a simple polyoxypropylene nominal diol, and residual unreacted monomeric polyisocyanate species. LINESTAR™ 4800 engineered lumber adhesive system has a viscosity at 25° C. of about 3000 cps and a final free —NCO concentration of about 19% by weight. It is a liquid resin that can be stored at 25° C. if protected from moisture. This liquid polyisocyanate adhesive reacts with moisture to form a crosslinked thermoset solid polyurethane-urea polymer. Further non-limiting examples of prepolymer containing one-component polyisocyanate adhesives suitable for use in the process, and detailed procedures for the preparation of such polyisocyanate adhesives, can be found in WO 200044803 and EP 0723561.

The term “polyisocyanate” as used herein is understood to encompass both diisocyanate and higher functionality isocyanate species. The expression “prepolymer containing polyisocyanate” as used herein is understood to encompass both pure isocyanate group terminated prepolymers that are devoid of other kinds of isocyanate species, as well as mixtures of isocyanate group terminated prepolymers with other isocyanate group terminated prepolymer species and/or with monomeric polyisocyanate species. All molecular weights, equivalent weights, or reactive group functionalities of polymeric species are understood to be number averaged unless otherwise specified. All molecular weights, equivalent weights, or reactive group functionalities of pure compounds are understood to be absolute unless otherwise specified.

The polyisocyanates suitable for use in the process may optionally contain added, but non-reacted catalysts. The catalysts should be of a type suitable for promoting the reaction of the polyisocyanate with moisture, but not sufficiently strong as to cause unwanted side reactions within the polyisocyanate prior to the exposure thereof to moisture. Non-limiting examples of optional catalysts suitable for use as non-reacted additives in the polyisocyanate adhesives include aliphatic tertiary amines and araliphatic tertiary amines that are free of active hydrogen functional groups. Specific examples of suitable non-reactive amine catalysts include 2,2′-dimorpholino diethyl ether (DMDEE) and 2,2′-dimethylamino diethyl ether. DMDEE is particularly preferred as an optional non-reactive catalyst. This compound is available commercially from Huntsman Petrochemical Corporation as JEFFCAT® DMDEE catalyst. The range of concentrations of the optional non-reactive catalyst, when it is used at all, in the total polyisocyanate adhesive composition (including any such optional catalyst) is from about 0.001% by weight to about 10% by weight of the total. However, the preferred concentration range is from about 0.01 to about 5% by weight, and more preferably from about 0.1 to about 2% by weight, still more preferably from about 0.2 to about 1% by weight, and most preferably from 0.25% to 0.75% by weight of the total polyisocyanate composition. The level of this optional additive should be only high enough to achieve the desired increase in cure rate, but not so high as to cause unwanted side reactions within the polyisocyanate prior to the exposure thereof to moisture. The adjustment of the optional catalyst level will be well understood by those skilled in the art.

The following examples are illustrative of the present invention, and are not intended to limit the scope of the invention in any way. Those of skill in the art should, in light of the present disclosure, appreciate that many changes can be made in the specific embodiments which are disclosed and still obtain a like or similar result without departing from the scope of the invention.

### EXAMPLES

Glossary:

1) % Moisture Content (of wood or wood products): is a standard industrial practice as defined by ASTM D4442 and is defined (briefly) as follows: [(Wt_{wet}−Wt_{dry})/Wt_{dry}]*100% where Wt_{wet} is the weight of the wood plus the water in it and or “wet” and Wt_{dry} is the weight of the wood on an oven dry basis.

2) A “Blow”: is an explosive degassing of the steam pressure within a wood product as it exists a hot press. A “blow” is considered a failed adhesive bond because normally the adhesive bond strength is greater than the internal pressure of the steam within a wood product to prevent this explosive degassing.

3) Chisel Test: is a non-standard yet industry-wide accepted test of LVL where a flat bladed chisel is placed on the edge of the LVL billets center glueline and is hammered through. The glueline is then inspected for qualitative bond quality although it is usually expressed in terms of a percentage wood failure with higher values of wood failure representing higher bond quality.

4) LINESTAR™ 4800 adhesive: is a liquid moisture curable isocyanate resin composition derived from the reaction of a mixture of MDI series polyisocyanates with a combination of polyols, the combination of polyols consisting of greater than 10% by weight of an ethylene diamine initiated polyoxyethylene-polyoxypropylene polyol. The ethylene diamine initiated polyol contains greater than 1% by weight of oxyethylene units in its polyether structure. It contains greater than 10% by weight of the ethylene diamine initiated polyether polyol. This prepolymer modified isocyanate product has a free —NCO content of about 19% by weight and is available commercially from Huntsman Polyurethanes.

A laminated beam was prepared with a final thickness of 6 inches by using LINESTAR™ 4800 engineered lumber adhesive system. The beam was prepared with 52 Douglas Fir veneers, each of ⅛ inch thickness. The LINESTAR™ 4800 engineered lumber adhesive system was applied to the veneers (all except the top most veneer) at an adhesive spread rate of 20 pounds per 1000 square feet of veneer. Water misting was used, at a spread rate of 5 pounds per 1000 square feet of veneer, to promote faster curing. This laminate was pressed at 250 psi for 30 minutes at ambient temperature (24° C.). The laminate was removed from the press and found to have been cured satisfactorily at that point. A PF type resin, by contrast, would not have cured at all under these conditions. It was estimated that a typical PF type resin would have required up to 6 hours of heating in the press in order to achieve adequate curing of such a thick laminate. Such a long duration of heating would have destroyed the outer layers of the laminate, rendering it useless.

LINESTAR 4800 Adhesive with a Ribbon Coater

LINESTAR™ 4800 adhesive was applied to veneers at an equivalent application rate of 20 pounds per thousand square feet of glueline (20 #/MSF). The adhesive was applied by passing the veneer under a ribbon coating application system that does not allow for the ingress of moisture from the air into the system at a constant speed such that the resulting measured application rate is achieved. The ribbon coating application system contained an extrusion head with three rows of offset extrusion points where each point is 1.5 mm in diameter and they are separated such that the resulting lines of extruded adhesive onto the veneer are separated by no more than 3.3 mm from center to center as seen in FIG. 1. After application of the adhesive, a water mist was sprayed (by any of a number of standard commercially available water misting techniques) into the adhesive coated veneer at a rate of 1-4 #/MSF to ensure adequate moisture is available to cure the adhesive.

PF Adhesive with a Ribbon Coater (Prophetic)

A standard, commercially available Phenol-Formaldehyde liquid adhesive used in the production of LVL (CASCOPHEN™ 54773 adhesive from Borden Chemicals) is applied to veneers at an equivalent application rate of 32 pounds per thousand square feet of glueline (32 #/MSF). The adhesive is applied by use of a ribbon coating application system that does not allow for the ingress of moisture from the air into the system. The ribbon coating application system contains an extrusion head with three rows of offset extrusion points where each point is 1.5 mm in diameter and they are separated such that the resulting lines of extruded adhesive onto the veneer are separated by no more than 3.3 mm from center to center as seen in FIG. 1.

LINESTAR 4800 Adhesive with a Curtain Coater (Prophetic)—NOT POSSIBLE

This combination of adhesive and application method is not possible. The curtain coater application method uses a recycle loop of adhesive as it passes through the air. LINESTAR 4800 adhesive would react with moisture in the air and would cure in the pump mechanism and adhesive delivery lines thus preventing application.

PF Adhesive with a Ribbon Coater (Prophetic)

A standard, commercially available Phenol-Formaldehyde liquid adhesive commonly used in the production of LVL (CASCOPHEN™ 54773 adhesive from Borden Chemicals) is applied to veneers at an equivalent application rate of 32 pounds per thousand square feet of glueline (32 #/MSF). The adhesive is applied by passing the veneer under a commercially available and commonly used ribbon coating application machine (Globe Machines LVL Curtain Coater) at a constant speed such that the resulting measured application rate is achieved.

Reduced Press Time

Twelve layers of ⅛″ thick Douglas Fir veneer, each with a moisture content of between 2% and 12%, were passed through the adhesive application system as noted in Table 1. They were then stacked together with an additional uncoated veneer layer (topsheet) such that grain patterns of the veneers were parallel. The stack of veneers (LVL billet) was then placed in a press at 315° F. and pressed at a pressure of 250 psi for the time noted in Table 1. The LVL billet is then removed from the press and tested for wood failure via a chisel test. The results are listed in Table 1.

TABLE 1
Chisel Test % Wood Failure with Variable Press Time

| | | | | PRF |
|---|---|---|---|---|
| | | PF adhesive | | adhesive w/ |
| | LINESTAR | w/a Ribbon | | a Curtain |
| | 4800 | Coater | LINESTAR 4800 | Coater |
| Press | w/a Ribbon | (Prophetic | w/a Curtain Coater | (Prophetic |
| Time | Coater | Results) | (Prophetic Results) | Results) |
| 25 min | 100% | 100% | Not possible due to | 100% |
| | | | equipment fouling | |
| 20 min | 100% | 95% | Not possible due to | 95% |
| | | | equipment fouling | |
| 15 min | 100% | 40% | Not possible due to | 40% |
| | | | equipment fouling | |
| 10 min | 100% | 0% | Not possible due to | 0% |
| | | | equipment fouling | |
| 8 min | 100% | 0% | Not possible due to | 0% |
| | | | equipment fouling | |
| 6 min | 95% | 0% | Not possible due to | 0% |
| | | | equipment fouling | |
| 5 min | 60% | 0% | Not possible due to | 0% |
| | | | equipment fouling | |

The Use of Increased Moisture Content Veneer

Twelve layers of ⅛″ thick Douglas Fir veneer, each with a moisture content as listed in Table 2 were passed through the adhesive application system as noted in Table 2. They were then stacked together with an additional uncoated veneer layer (topsheet) such that grain patterns of the veneers are parallel. The stack of veneers (LVL billet) was then placed in a press at 315° F. and pressed at 250 psi for a twenty minute press time. The LVL billet was then removed from the press and tested for wood failure via a chisel test. The results are listed in Table 2.

TABLE 2
Chisel Test % Wood Failure with Variable
% Moisture Content of the Veneer

| | | | | PRF |
|---|---|---|---|---|
| | | PF | | adhesive |
| | | adhesive | | w/a |
| | LINESTAR | w/a Ribbon | LINESTAR 4800 | Curtain |
| % | 4800 | Coater | w/a Curtain | Coater |
| Moisture | w/a Ribbon | (Prophetic | Coater(Prophetic | (Prophetic |
| Content | Coater | Results) | Results) | Results) |
| 2-6% | 100% | 100% | Not possible due to | 100% |
| | (prophetic) | | equipment fouling | |
| 6-10% | 100% | 95% | Not possible due to | 95% |
| | (prophetic) | | equipment fouling | |
| 10-15% | 100% | 80% | Not possible due to | 80% |
| | | | equipment fouling | |
| 15-20% | 100% | 0% | Not possible due to | 0% |
| | (prophetic) | “Blows” | equipment fouling | “Blows” |
| 30-40% | 100% | 0% | Not possible due to | 0% |
| | | “Blows” | equipment fouling | “Blows” |
| 50-100% | 100% | 0% | Not possible due to | 0% |
| | | “Blows” | equipment fouling | “Blows” |
| >100% | 100% | 0% | Not possible due to | 0% |
| | | “Blows” | equipment fouling | “Blows” |

Reduced Temperature Curing

Twelve layers of ⅛″ thick Douglas Fir veneer, each with a moisture content of between 2% and 12%, were passed through the adhesive application system as noted in Table 3a and 3b. They were then stacked together with an additional uncoated veneer layer (topsheet) such that grain patterns of the veneers were parallel. The stack of veneers (LVL billet) was then placed in a press at the temperature listed as noted and pressed at a pressure of 250 psi for the time listed as noted Table 3a or 3b. The LVL billet was then removed from the press and tested for wood failure via a chisel test.

TABLE 3a
Chisel Test % Wood Failure w/Variable Press
Temperature and 30′ Press Time

| | | PF | | PRF |
|---|---|---|---|---|
| | | adhesive | | adhesive |
| | LINESTAR | w/a Ribbon | | w/a Curtain |
| Press | 4800 | Coater | LINESTAR 4800 | Coater |
| Temp | w/a Ribbon | (Prophetic | w/a Curtain Coater | (Prophetic |
| (° F.) | Coater | Results) | (Prophetic Results) | Results) |
| 320 | 100% | 100% | Not possible due to | 100% |
| | (prophetic) | | equipment fouling | |
| 300 | 100% | 80% | Not possible due to | 80% |
| | (prophetic) | | equipment fouling | |
| 275 | 100% | 0% | Not possible due to | 0% |
| | (prophetic) | “Blows” | equipment fouling | “Blows” |
| 250 | 100% | 0% | Not possible due to | 0% |
| | (prophetic) | “Blows” | equipment fouling | “Blows” |
| 200 | 100% | 0% | Not possible due to | 0% |
| | | | equipment fouling | |
| 150 | 100% | 0% | Not possible due to | 0% |
| | | | equipment fouling | |
| 75 | 100% | 0% | Not possible due to | 0% |
| | | | equipment fouling | |

TABLE 3b
Chisel Test % Wood Failure w/Variable Press
Temperature and 10′ Press Time

| | | PF adhesive | | PRF adhesive |
|---|---|---|---|---|
| | LINESTAR | w/a Ribbon | | w/a Curtain |
| Press | 4800 | Coater | LINESTAR 4800 | Coater |
| Temp | w/a Ribbon | (Prophetic | w/a Curtain Coater | (Prophetic |
| (° F.) | Coater | Results) | (Prophetic Results | Results) |
| 320 | 100% | 0% | Not possible - | 0% |
| | (prophetic) | “Blows” | equipment fouling | “Blows” |
| 300 | 100% | 0% | Not possible - | 0% |
| | (prophetic) | “Blows” | equipment fouling | “Blows” |
| 275 | 100% | 0% | Not possible - | 0% |
| | (prophetic) | “Blows” | equipment fouling | “Blows” |
| 250 | 100% | 0% | Not possible - | 0% |
| | | “Blows” | equipment fouling | “Blows” |
| 200 | 100% | 0% | Not possible - | 0% |
| | | | equipment fouling | |
| 150 | 95% | 0% | Not possible - | 0% |
| | (prophetic) | | equipment fouling | |
| 75 | 60% | 0% | Not possible - | 0% |
| | (prophetic) | | equipment fouling | |

Greater Thickness LVL in a Single Manufacturing Step

Reduced Press Time

Enough layers of ⅛″ thick Douglas Fir veneer, each with a moisture content of between 2% and 12%, are passed through the adhesive application system as noted in the table to created an LVL billet with the final thickness as noted in Table 4. They are then stacked together with an additional uncoated veneer layer (topsheet) such that grain patterns of the veneers are parallel. The stack of veneers (LVL billet) is then placed in a press at 315° F. and pressed at a pressure of 250 psi for 30 minutes. The LVL billet is then removed from the press and tested for wood failure via a chisel test. The results are listed in Table 4.

TABLE 4
Chisel Test % Wood Failure with Variable LVL Billet Thickness

| | | | | PRF |
|---|---|---|---|---|
| | | | | adhesive |
| | | PF adhesive | | w/a |
| | LINESTAR | w/a Ribbon | | Curtain |
| LVL | 4800 w/a | Coater | LINESTAR 4800 w/ | Coater |
| Billet | Ribbon | (Prophetic | a Curtain Coater | (Prophetic |
| Thickness | Coater | Results) | (Prophetic Results) | Results) |
| 1.5″ | 100% | 100% | Not possible due to | 100% |
| | | | equipment fouling | |
| 2.0″ | 100% | 90% | Not possible due to | 90% |
| | | | equipment fouling | |
| 2.5″ | 100% | 60% | Not possible due to | 60% |
| | | | equipment fouling | |
| 3.0″ | 100% | 0% | Not possible due to | 0% |
| | | | equipment fouling | |
| 3.5″ | 100% | 0% | Not possible due to | 0% |
| | | | equipment fouling | |
| 4.75″ | 100% | 0% | Not possible due to | 0% |
| | | | equipment fouling | |
| 6.0″ | 100% | 0% | Not possible due to | 0% |
| | | | equipment fouling | |

What is claimed:

1. A process for the manufacture of laminated wood composites comprising the steps of:
(a) providing a plurality of wood veneers;
(b) providing an organic polyisocyanate laminating adhesive;
(c) providing a ribbon coating apparatus;
(d) providing a pressing means;
(e) conveying at least one of the plurality of wood veneers through the ribbon coating apparatus and applying a layer of the organic polyisocyanate laminating adhesive in liquid form to a face of the at least one wood veneer in a single pass through the ribbon coating apparatus to obtain a liquid polyisocyanate coated veneer;
(f) placing at least one of the liquid polyisocyanate coated veneers in contact with at least one other veneer to form a loose stack of veneers;
(g) pressing the loose stack of veneers in the pressing means under conditions suitable to cause the polyisocyanate laminating adhesive to at least partially cure to form an adhesive bonded wood laminate; and
(h) removing the adhesive bonded wood laminate from the pressing means.

2. The process according to claim 1 wherein the pressing is conducted within a temperature range of from 10° C. to 50° C.

3. The process according to claim 2 wherein the plurality of wood veneers each has a moisture content of less than 20% by weight, relative to the total weight of the veneer.

4. The process according to claim 1 wherein the plurality of wood veneers each has a moisture content of less than 20% by weight, relative to the total weight of the veneer.

5. The process according to claim 4 wherein the pressing is conducted within a temperature range of from 10° C. to 50° C.

6. The process according to claim 1 wherein the organic polyisocyanate laminating adhesive is a one component moisture curing quasiprepolymer comprising at least one —N═C═O group terminated prepolymer derived from the reaction of an aliphatic tertiary amine initiated polyether polyol with a molar excess of one or more monomeric polyisocyanate species of the MDI series; and wherein said quasiprepolymer further contains, in unreacted form, some monomeric polyisocyanate species of the MDI series.

7. The process according to claim 2 wherein the organic polyisocyanate laminating adhesive is a one component moisture curing quasiprepolymer comprising at least one —N═C═O group terminated prepolymer derived from the reaction of an aliphatic tertiary amine initiated polyether polyol with a molar excess of one or more monomeric polyisocyanate species of the MDI series; and wherein said quasiprepolymer further contains, in unreacted form, some monomeric polyisocyanate species of the MDI series.

8. The process according to claim 6 wherein the aliphatic tertiary amine initiated polyether polyol contains a plurality of oxyethylene groups.

9. The process according to claim 7 wherein the aliphatic tertiary amine initiated polyether polyol contains a plurality of oxyethylene groups.

10. The process according to claim 8 wherein the aliphatic tertiary amine initiated polyether polyol is prepared from the reaction of a polyfunctional aliphatic amine initiator with ethylene oxide and propylene oxide.

11. The process according to claim 9 wherein the aliphatic tertiary amine initiated polyether polyol is prepared from the reaction of a polyfunctional aliphatic amine initiator with ethylene oxide and propylene oxide.

12. The process according to claim 10 wherein the polyfunctional aliphatic amine initiator consists essentially of ethylene diamine.

13. The process according to claim 11 wherein the polyfunctional aliphatic amine initiator consists essentially of ethylene diamine.

14. The process according to claim 6 wherein the one component moisture curing quasiprepolymer has a free —N═C═O group concentration in the range of from 10 to 29% by weight, a number average —N═C═O group functionality of greater than 2, and a viscosity at 25° C. in the range of from 200 to 10,000 cps.

15. The process according to claim 7 wherein the one component moisture curing quasiprepolymer has a free —N═C═O group concentration in the range of from 10 to 29% by weight, a number average —N═C═O group functionality of greater than 2, and a viscosity at 25° C. in the range of from 200 to 10,000 cps.

16. The process according to claim 14 wherein the pressing is conducted within a temperature range of from 15° C. to 30° C.

17. The process according to claim 15 wherein the pressing is conducted within a temperature range of from 15° C. to 30° C.

18. A laminated wood product produced according to the process of claim 1.

19. The laminated wood product of claim 18 wherein the total amount of organic polyisocyanate laminating adhesive in the laminated wood product is from about 0.25 to 1% by weight.

20. A laminated wood product produced according to the process of claim 3.
